(19) United States
(12) Patent Application Publication
(10) Pub. No.: US 2010/0105889 A1
(43) Pub. Date: Apr. 29, 2010

(54) PROCESS FOR THE PREPARATION OF PENTOSAN POLYSULFATE OR SALTS THEREOF

(76) Inventors: Pandurang Balwant Deshpande, Gujarat (IN); Parvenkumar Luthra, Gujarat (IN); Anand Kumar Pandey, Gujarat (IN); Dinesh Jayntibhai Paghdar, Gujarat (IN); Phani,Sharma,Gowthamaiah Vemavarapu Govardhana, Gujarat (IN)

Correspondence Address: Gregory A. Nelson;Novak Druce & Quigg LLP, 525 Okeechobee Blvd, Suite 1500, West Palm Beach, FL, 33401, US

(21) Appl. No.: 12/530,320

(22) PCT Filed: May 16, 2007
(86) PCT No.: PCT/IN07/00198

§ 371 Date: Sep. 8, 2009

(51) Int. Cl. C08B 37/00

(52) U.S. Cl. 536/122

(57) ABSTRACT

A process for the preparation of Pentosan polysulfate sodium comprising a step of purifying depolymerized crude Pentosan polysulfate sodium by filtration through NF membrane system.

### FIELD OF INVENTION

The present invention relates to an improved process for the preparation of Pentosan polysulfate of formula (I)

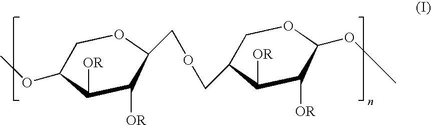

or salt thereof, wherein R represents —SO₃Y, and Y is at least one member selected from the group consisting of H and a pharmaceutically acceptable cation such as sodium, potassium, and magnesium. It also provides an amorphous form of Pentosan polysulfate sodium and process thereof.

### BACKGROUND OF THE INVENTION

Pentosan polysulfate sodium is chemically known as β-D-Xylan, (1-4), 2, 3-bis (hydrogen sulphate) sodium salt having molecular weight range of 4000 to 6000 Dalton. The structural formula of Pentosan polysulfate sodium represents as below:

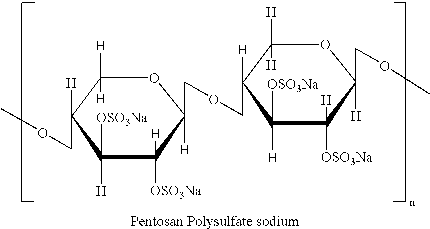

The current pharmaceutical product containing Pentosan polysulfate sodium salt is being sold by Ortho McNeil under the tradename Elmiron® in the form of capsules which is used for the treatment of bladder infection, interstitial cystitis and tumors.

Pentosan polysulfate sodium [37319-17-8] is a semi-synthetically produced heparin-like macromolecular carbohydrate derivative which chemically and structurally resembles glycosaminoglycans. It is a white odorless powder, slightly hygroscopic and soluble in water to 50% at pH 6.

Pentosan polysulfate sodium is a mixture of linear polymers of β-1→4-linked xylose, usually sulfated at the 2- and 3-positions and occasionally substituted at the 2-position with 4-O-methyl-α-D-glucuronic acid 2, 3-O-sulfate.

Pentosan polysulfate is a semi-synthetic compound whose polysaccharide backbone, xylan is extracted from the bark of the beech tree or other plant sources and then treated with sulfating agents such as chlorosulfonic acid or sulfuryl chloride and acid. After sulfation, Pentosan polysulfate is usually treated with sodium hydroxide to yield the sodium salt.

Pentosan polysulfate is disclosed in U.S. Pat. No. 2,689,848. The process wherein Xylan is treated with chlorosulfonic acid in the presence of pyridine to obtain sulfuric acid ester salt of xylan followed by oxidative depolymerisation in acidic or neutral aqueous medium to obtain depolymerised product which is dialyzed and followed the fractionation process to obtain desired product. However, this process does not provide end product with desired molecular weight.

U.S. Pat. No. 2,689,848 disclosed the process for the production of salts of sulfuric acid ester of Xylan, the steps which comprise oxidizing the aqueous solution of the a salt of a sulfuric acid ester of highly polymeric xylan in an aqueous solution of H₂O₂ and H₂SO₄ to depolymerize such highly polymeric xylan ester partially, dialyzing the depolymerized product and fractionating an aqueous solution of the dialyzate with an organic water miscible solvent to obtain a fraction having a Z□ value between 0.0030 and 0.015 and sulfur content of 13.5 to 17%.

Moreover, the process as disclosed above for the preparation of Pentosan polysulfate is tedious, costly and provides low yield of final product. Moreover, the use of cellophane tubes for dialysis makes process inapplicable at industrial scale up.

Therefore, it is necessary to develop a process for preparation of Pentosan polysulfate sodium which provides good yield as well as operationally simple and easily applicable at an industrial scale.

Surprisingly, the present inventors have found that carrying out the purification of crude Pentosan polysulfate of formula (I) or its salt by dissolving it in water, followed by filtration through NF membrane system and crystallization of resulting mixture from alcohol provides high yield with good purity of Pentosan polysulfate of formula (I) or its salt of molecular weight of 3000 to 10000 Dalton.

### OBJECTS OF THE INVENTION

It is therefore an object of the present invention is to provide an improved process for the preparation of Pentosan polysulfate of formula (I) or salt thereof.

Another object of the present invention is to provide the process for the preparation of Pentosan polysulfate of formula (I) or its salt which is operationally simple, easy to handle and applicable at an industrial scale.

A furthermore object of the present invention is to provide an amorphous form of Pentosan polysulfate of formula (I) or its salt thereof.

Another object of the present invention is to provide an amorphous form of Pentosan polysulfate sodium.

Yet another object of the present invention is to provide an improved process for preparation of Pentosan polysulfate of formula (I) or salt thereof, comprising steps of:
i) treating xylan with chlorosulfonic acid in the presence of pyridine followed by addition of alkali in the presence of alcoholic solvent to obtain salt of sulfuric acid ester of xylan
ii) oxidizing the salt of sulfuric acid ester of xylan with the mixture of H₂SO₄ and 30% H₂O₂ to obtain depolymerized crude Pentosan polysulfate of formula (I) or its salt
iii) purifying depolymerized crude Pentosan polysulfate of formula (I) or its salt by dissolving it in water, followed by filtration through NF membrane system
iv) crystallizing the product obtained in the step (iii) from alcohol to obtain pure Pentosan polysulfate of formula (I) or its salt

A further object of the present invention is to provide an improved process for purification of Pentosan polysulfate of formula (I) or salt thereof, comprising steps of
i) dissolving crude Pentosan polysulfate of formula (I) or its salt in water
ii) filtering the reaction mixture obtain in the step (i) with NF membrane system
iii) crystallizing the resulting product obtained in the step (ii) from alcohol to obtain pure Pentosan polysulfate of formula (I) or its salt

Yet another object of the present invention is to provide an improved process for preparation of Pentosan polysulfate sodium, comprising steps of:
i) treating xylan with chlorosulfonic acid in the presence of pyridine followed by addition of sodium hydroxide in the presence of alcoholic solvent to obtain sodium salt of sulfuric acid ester of xylan
ii) oxidizing the sodium salt of sulfuric acid ester of xylan with the mixture of H₂SO₄ and 30% H₂O₂ to obtain depolymerized crude Pentosan polysulfate sodium
iii) purifying depolymerized crude Pentosan polysulfate sodium, by dissolving it in water, followed by filtration through NF membrane system
iv) lyophilizing the product obtained in the step (iii) to obtain pure Pentosan polysulfate sodium

A further object of the present invention is to provide an improved process for purification of Pentosan polysulfate sodium, comprising steps of:
i) dissolving crude Pentosan polysulfate sodium in water
ii) filtering the reaction mixture obtain in the step (i) with NF membrane system
iii) lyophilizing the resulting product obtained in the step (ii) to obtain pure Pentosan polysulfate sodium

### SUMMARY OF THE INVENTION

According to one aspect, present invention provides an improved process for the preparation of Pentosan polysulfate of formula (I),

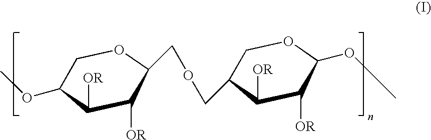

or salt thereof, wherein R represents —SO₃Y, and Y is at least one member selected from the group consisting of H and a pharmaceutically acceptable cation such as sodium, potassium, and magnesium said process
comprising steps of:
i) treating xylan with chlorosulfonic acid in the presence of pyridine followed by addition of alkali in the presence of alcoholic solvent to obtain salt of sulfuric acid ester of xylan;
ii) oxidizing the salt of sulfuric acid ester of xylan with the mixture of H₂SO₄ and 30% H₂O₂ to obtain depolymerized crude Pentosan polysulfate of formula (I) or its salt;
iii) purifying depolymerized crude Pentosan polysulfate of formula (I) or its salt by dissolving it in water, followed by filtration through NF membrane system;
iv) crystallizing the product obtained in the step (iii) from alcohol to obtain pure Pentosan polysulfate of formula (I) or its salt.

Further aspect of the present invention is to provide an improved process for purification of Pentosan polysulfate of formula (I) or salt thereof, comprising steps of:
i) dissolving crude Pentosan polysulfate of formula (I) or its salt in water;
ii) filtering the reaction mixture obtain in the step (i) with NF membrane system;
iii) crystallizing the resulting product obtained in the step (ii) from alcohol to obtain pure Pentosan polysulfate of formula (I) or its salt.

Further aspect of the present invention is to provide an improved process for preparation of Pentosan polysulfate sodium, comprising steps of:
i) treating xylan with chlorosulfonic acid in the presence of pyridine followed by addition of sodium hydroxide in the presence of alcoholic solvent to obtain sodium salt of sulfuric acid ester of xylan;
ii) oxidizing the sodium salt of sulfuric acid ester of xylan with the mixture of H₂SO₄ and 30% H₂O₂ to obtain depolymerized crude Pentosan polysulfate sodium;
iii) purifying depolymerized crude Pentosan polysulfate sodium by dissolving it in water, followed by filtration through NF membrane system;
iv) lyophilizing the product obtained in the step (iii) to obtain pure Pentosan polysulfate sodium.

A further object of the present invention is to provide an improved process for purification of Pentosan polysulfate sodium, comprising steps of:
i) dissolving crude Pentosan polysulfate sodium in water
ii) filtering the reaction mixture obtain in the step (i) with NF membrane system
iii) lyophilizing the resulting product obtained in the step (ii) to obtain pure Pentosan polysulfate sodium

### BRIEF DESCRIPTION OF THE DRAWINGS

FIG. 1 represents the powder X-ray diffraction (XRD) pattern of an amorphous form of Pentosan polysulfate sodium.

### DETAILED DESCRIPTION OF THE INVENTION

The process of the present invention for preparation of Pentosan polysulfate of formula (I) or salt thereof, is operationally simple, easy to handle and applicable at an industrial scale.

The present invention provides an improved process for preparation of Pentosan polysulfate of formula (I) or salt thereof, comprising steps of:
i) treating xylan with chlorosulfonic acid in the presence of pyridine followed by addition of alkali in the presence of alcoholic solvent to obtain salt of sulfuric acid ester of xylan
ii) oxidizing the salt of sulfuric acid ester of xylan with the mixture of H₂SO₄ and 30% H₂O₂ to obtain depolymerized crude Pentosan polysulfate of formula (I) or its salt
iii) purifying depolymerized crude Pentosan polysulfate of formula (I) or its salt by dissolving it in water, followed by filtration through NF membrane system
iv) crystallizing the product obtained in the step (iii) from alcohol to obtain pure Pentosan polysulfate of formula (1) or its salt

The suitable alkali in step (i) is selected from alkali metal salt of carbonate, bicarbonate, hydroxide or mixtures thereof. The most preferable is sodium hydroxide. The suitable alcoholic solvent in step (i) is selected from methanol, ethanol, propanol, isopropanaol, butanol or mixtures thereof. The most preferable is methanol. The suitable alcohol in step (iv) is selected from methanol, ethanol, propanol, isopropanaol, butanol or mixtures thereof. The most preferable is methanol. Crystallization provides an amorphous form of Pentosan polysulfate of formula (I) or its salt.

The present invention also provides an improved process for preparation of Pentosan polysulfate sodium, comprising steps of:
i) treating xylan with chlorosulfonic acid in the presence of pyridine followed by addition of sodium hydroxide in the presence of alcoholic solvent to obtain sodium salt of sulfuric acid ester of xylan
ii) oxidizing the sodium salt of sulfuric acid ester of xylan with the mixture of H₂SO₄ and 30% H₂O₂ to obtain depolymerized crude Pentosan polysulfate sodium
iii) purifying depolymerized crude Pentosan polysulfate sodium by dissolving it in water, followed by filtration through NF membrane system
iv) lyophilizing the product obtained in the step (iii) to obtain pure Pentosan polysulfate sodium

The suitable alcoholic solvent in step (i) is selected from methanol, ethanol, propanol, isopropanaol, butanol or mixtures thereof. The most preferable is methanol. Lyophilization provides an amorphous form of Pentosan polysulfate of formula (I) or its salt.

According to present invention, pyridine is added in chlorosulfonic acid slowly at below 40-50° C. The resulting salt was heated to 60-65° C. before addition of xylan and raised the temperature to 75-80° C. After completion of reaction, reaction mixture is cooled to 25-30° C. and added methanol to isolate the pyridinium salt. The isolated pyridinium salt is dissolved in water and decolorized with chlorine dioxide, then it is quenched with alkaline methanol. It is then adjusted pH 6.5-7.0 with glacial acetic acid, filtered and dried the material at 50-55° C. under reduced pressure to get the sodium salt of sulfuric acid ester of xylan.

Sodium salt of sulfuric acid ester of xylan is dissolved in water and heated to 90-100° C., then added preheated mixture of 5N H₂SO₄ and 30% hydrogen peroxide. The reaction mixture is maintained at 90-100° C. After completion of reaction, the reaction mixture is cooled to 25-30° C. and adjusted pH 7.5-7.3 with 5N sodium hydroxide solution. Then this reaction mixture is precipitated with methanol, filtered and dried to get the depolymerized product i.e. crude Pentosan polysulfate sodium.

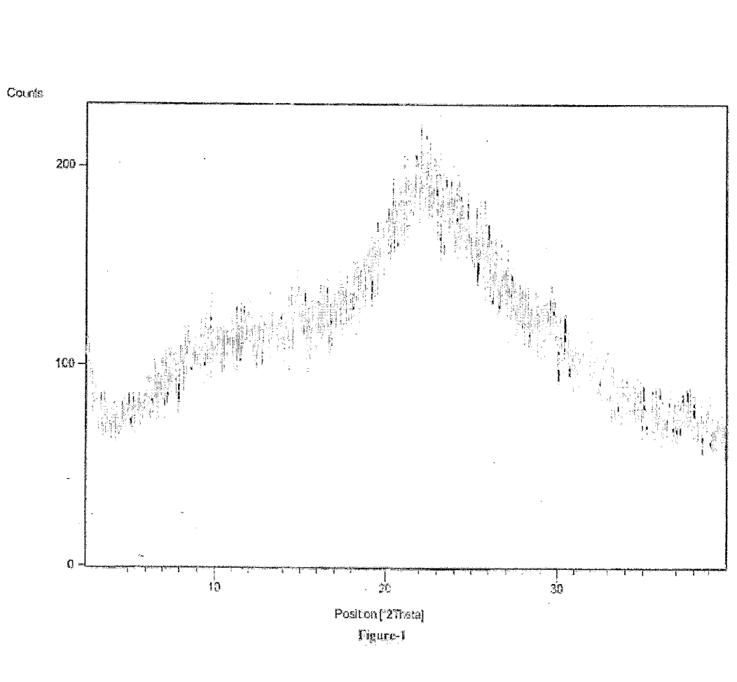

The depolymerized product is dissolved in water and subjected to NF Membrane system of cut off molecular weight of 3000 Dalton and monitored the rejection of lower molecular weight material with gel permeation chromatography. After the completion of reaction, the concentrate was subjected to water recovery at 40-50° C. Finally residue was crystallized with methanol to get the pure amorphous form of Pentosan polysulfate sodium having Z□ value 0.006 and Molecular weight of 6543 Dalton. X-ray powder diffraction pattern is matching with FIG. 1.

Moreover, after the completion of filtration, the concentrate is transferred in a single neck round bottom flask and fitted to Lyophilizer (BT4KZL-105) and starts the operation of lyophilyzation. It takes about 24 hr to complete the lyophilyzation and provides an amorphous form of Pentosan polysulfate having Z□ value −0.007 and Mol weight of 5406 Dalton. X-ray powder diffraction pattern is matching with FIG. 1.

In the present invention, the purification step as discussed hereinabove is carried out by using “PERMA” Pilot Membrane System manufactured by PERMIONIC Membranes Pvt. Ltd., 3/29, 4/19, B.I.D.C., Gorwa Estate, Vadodara-390016, Gujarat, India.

In accordance with the aspects of this invention, purification of crude Pentosan polysulfate of formula (I) or its salt is carried out in following manner:

The crude Pentosan polysulfate of formula (I) or its, salt is dissolved in water. Feeding the resultant solution and allow it to pass through micron filter membrane system and concentrate flow meter, thereby filtering out the Pentosan polysulfate of formula (I) or its salt with desired molecular weight in the range of 3000 to 10000 Dalton.

For the purpose of this specification, the meaning of the term “NF membrane system” is nano-filtration accompanied by membrane which is capable to pass the undesired product having molecular weight of at least 3000 Dalton.

Advantages of the present invention over prior art:
i) The present invention provides process which is economical, operationally and industrially applicable.
ii) The present invention provides cheaper as well as less time consuming process for the preparation of Pentosan polysulfate sodium.
iii) The process is simple and easy to handle and does not require special handling care or critical conditions.
iv) The process provides the desired Pentosan polysulfate sodium with molecular weight of 3000 to 10000 Dalton specifically.

The process of the present invention is described by the following examples, which are illustrative only and should not be construed so as to limit the scope of the invention in any manner.

### EXAMPLE 1

To a three neck 3 lt round bottom flask the pyridine (800 ml) and chlorosulfonic acid (200 ml) was added slowly at below 40-50° C. The resulting salt was heated to 60-65° C. then added xylan (100 g) and raised the temperature to 75-80° C. After completion of reaction, reaction mixture was cooled to 25-30° C. and methanol was added (2500 ml) to isolate the pyridine salt of xylan. The isolated pyridine salt of xylan was dissolved in water 500 ml and decolorized with chlorine dioxide (200 ml), then it was added a mixture of methanol (2000 ml) and 33% Sodium hydroxide (200 ml). It was then adjusted to pH to neutral with acetic acid, filtered and dried the material at 50-55° C. under reduced pressure to get 240 gm sodium salt of sulfuric acid ester of xylan.

To a three neck 3 lt round bottom flask charged sodium salt of sulfuric acid ester of xylan (500 g) in water (1500 ml) and heated to 90-100° C., then added the preheated mixture of 5N sulfuric acid (25 ml) and 30% hydrogen peroxide (250 ml). Monitored the reaction with HPLC, after completion of reaction till average molecular weight came about 4000-8000 Dalton, cooled the reaction mixture and solution was adjusted pH to neutral with dilute sodium hydroxide solution. Then the reaction mixture was precipitated with methanol (12 lt), filtered and dried at 50-55° C. to get crude Pentosan polysulfate sodium having yield of 450 gm and Z□ value −0.006.

The 450 gm of the crude Pentosan polysulfate sodium was dissolved in water (20 lt) and subjected to the NF membrane of cut off molecular weight of 3000 Dalton, filtration. The NF Membrane system was monitored the rejection of lower molecular weight material with HPLC. After the completion of filtration, the concentrate was subjected to water recovery at 40-50° C. under reduced pressure up to 340 ml. Finally residue was crystallized with methanol (2.7 lt) to get the pure Pentosan polysulfate sodium. Filtered the material and dried it at 45-50° C. under vacuum. The yield of pure Pentosan polysulfate sodium was 170 gm having Z□ value 0.006 and Molecular weight of 6543 Dalton.

X-ray powder diffraction pattern is matching with FIG. 1.

### EXAMPLE 2

To a three neck 3 lt round bottom flask the pyridine (800 ml) and chlorosulfonic acid (200 ml) was added slowly at below 40-50° C. The resulting salt was heated to 60-65° C. then added xylan (100 g) and raised the temperature to 75-80° C. After completion of reaction, the reaction mass was cooled 25-30° C. and added methanol (2500 ml) to isolate the pyridine salt of xylan. The isolated pyridine salt of xylan was dissolved in water 500 ml and decolorized with chlorine dioxide (200 ml), then it was added a mixture of methanol (2000 ml) and 33% Sodium hydroxide (200 ml). It was then adjusted to pH to neutral with acetic acid, filtered and dried the material at 50-55° C. under reduced pressure to get 240 gm of sodium salt of sulfuric acid ester of xylan.

To a three neck 1 lt round bottom flask, charged sodium salt of sulfuric acid ester of xylan (200 g) in water (600 ml). The reaction was heated to 90-100° C., then added preheated mixture of 5N sulfuric acid (10 ml) and 30% hydrogen peroxide (100 ml).

Monitored the reaction with HPLC after completion of reaction, till average molecule weight came about 4000-8000 Dalton cooled the reaction mixture and the solution was adjusted pH to neutral with diluted sodium hydroxide solution. Then the reaction mixture was subjected to NF membrane system.

The above reaction mixture was diluted with water (20 lt) and subjected to the NF membrane of cut off molecular weight of 3000 Dalton, filtration. The NF Membrane system was monitored the rejection of lower molecular weight material with HPLC. After the completion of filtration, the concentrate was transferred in a single neck round bottom flask and fitted to Lyophilizer (BT4KZL-105) and started the operation of lyophilyzation. It took about 24 hr to complete the lyophilyzation. The yield of amorphous form of Pentosan polysulfate was 60 gm and Mol wt.-5406 and Z□ value −0.007.

X-ray powder diffraction pattern is matching with FIG. 1.

1. A process for preparation of Pentosan polysulfate of formula (I) 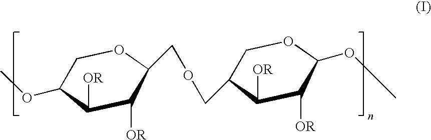
or salts thereof, wherein R represents —SO₃Y, and Y is at least one member selected from the group consisting of H and a pharmaceutically acceptable cation such as sodium, potassium, and magnesium,
comprising steps of:
treating xylan with chlorosulfonic acid in the presence of pyridine followed by addition of alkali in the presence of alcoholic solvent to obtain salt of sulfuric acid ester of xylan
ii) oxidizing the salt of sulfuric acid ester of xylan with the mixture of H₂SO₄ and 30% H₂O₂ to obtain depolymerized crude Pentosan polysulfate of formula (I) or its salt
iii) purifying depolymerized crude Pentosan polysulfate of formula (I) or its salt by filtration through NF membrane system
iv) crystallizing the product obtained in the step (iii) from alcohol to obtain pure Pentosan polysulfate of formula (I) or its salt

2. A process as claimed in claim 1, wherein said alkali in step (i) is selected from alkali metal salt of carbonate, bicarbonate, hydroxide or mixtures thereof

3. A process as claimed in claim 1, wherein said alcoholic solvent in step (i) is selected from methanol, ethanol, propanol, isopropanaol, butanol or mixtures thereof.

4. A process as claimed in claim 1, wherein said purification in step (iii) is carried out by dissolving crude Pentosan polysulfate of formula (I) or its salt in water and followed by filtration through NF membrane system.

5. A process as claimed in claim 1, wherein said alcohol in step (iv) is selected from methanol, ethanol, propanol, isopropanaol, butanol or mixtures thereof.

6. (canceled)

7. (canceled)

8. An amorphous form of Pentosan polysulfate sodium with molecular weight range of 3000 to 10000 Dalton and XRD pattern as shown in FIG. 1.

9. (canceled)

10. (canceled)

11. (canceled)

12. (canceled)

13. A process for the preparation of Pentosan polysulfate sodium comprising a step of purifying depolymerized crude Pentosan polysulfate sodium by filtration through NF membrane system.

14. A process as claimed in claim 13, wherein said purification is carried out by dissolving crude Pentosan polysulfate sodium in water and followed by filtration through NF membrane system.

15. (canceled)

16. (canceled)

17. (canceled)

18. (canceled)
